(19) United States
(12) Patent Application Publication
(10) Pub. No.: US 2007/0040055 A1
(43) Pub. Date: Feb. 22, 2007

(54) Method and apparatus for pulverizing solid materials

(76) Inventors: Robert D. Riendeau, Springfield, MA (US); Francis T. Federico, Longmeadow, MA (US); Kim A. Wynns, Swedesboro, NJ (US)

Correspondence Address: BUCHANAN INGERSOLL & ROONEY PC, P.O. BOX 1404, ALEXANDRIA, VA, 22313-1404, US

(21) Appl. No.: 11/205,385

(22) Filed: Aug. 17, 2005

(51) Int. Cl. B02C 13/00

(52) U.S. Cl. 241/23; 241/65; 241/188.1

(57) ABSTRACT

A method and apparatus to pulverize materials directs solid materials through a generally horizontal chamber. A rotating center element that directs the material along the chamber by basic thrust using projections such as tines, paddles, knives or blades to develop motion and resulting kinetic energy of the material. The material is directed along the axis from the material inlet toward the material outlet and reverses flow at the end of the chamber to recycle back toward the material inlet causing particles of material to collide and fracture. The rotating speed of the center element can be adjusted to affect the grinding rates and particle size distribution. The rotating center element can also be fixtured to optimize material size reduction, differences in material density and the horizontal chamber can be tilted in a declined or inclined plane to affect the grinding rates and size reduction. This method of grinding and pulverizing can accommodate material feed stocks that have as much as 10% moisture since the grinding action creates heat and can drive off the moisture from the material.

### FIELD OF INVENTION

The invention relates to a grinding or pulverizing system for reducing material in size.

### BACKGROUND OF THE INVENTION

Materials have been ground and pulverized historically by either driving the material between two harder surfaces such as the traditional mortar and pestle or by striking material against a hard surface. More recent methods of grinding have taken material and accelerated it with a compressed air source to generate sufficient kinetic energy to fracture the material upon impact with a hard surface. Coffee is ground with the more traditional method of applying a force to the coffee beans between two equally hard surfaces. Vertical shaft grinders today use hammers or comminutors to reduce the particle size of materials. Grinding, or cutting, such as with knives, is yet another subset of grinding with the majority of feed material reduction accomplished via the cutting or cleaving with a hard edge. The term “comminutor” originated with a device for chopping meat. It was later applied to equipment used for grinding pharmaceuticals, wastewater solids and other materials. The term grinder, as in meat grinder, is commonly used to imply a comminutor that reduces solids finely and often has multitudes of cutting edges. Regardless of the method of reducing the size of material, there have been numerous applications of the grinding and pulverizing of materials using direct energy input to reduce the material in size.

1. Brief Description of the Prior Art

The prior art of grinding and pulverizing has been accomplished by placing larger material between two harder surfaces and applying a force to the material to be ground by one or both of the opposing harder surfaces. The typical coffee grinder is a good example of this method of reducing larger material into smaller material. Variations of this method have added hammers impacting material between two harder surfaces or even high speed flailing of chains and hammers as described in U.S. Pat. No. 5,184,781 to Andela. Other methods have been developed such as described in U.S. Pat. No. 5,316,222 where gas pressure propels the particles and these particles collide with a hard surface. In this patent, the feed material is given a velocity with an acceleration component that imparts kinetic energy into the material to be ground and then directs it to a harder surface to fracture the feed material into smaller sizes.

In most cases, the prior art uses rotating chambers to transport the feed material along the impact sites in one form or another such as described by Holcomb, et al. in U.S. Pat. No. 6,672,524 “Multiple chamber condiment grinder”. This device has more than one chamber that commutates the feed material from one chamber to the next affecting the grinding function by reducing the feed material. Again, this method uses the typical applied force from the drive mechanism to force the feed material into a hard surface to grind or reduce the feed material into smaller sizes.

U.S. Pat. No. 5,865,383 discloses a high volume grinder, but does not describe the grinding mechanism in great detail. Rather, there is a detailed description of how the feed material is controlled in the grinder, how the ground material is collected and ancillary controls used to manipulate the finished product or recycle material. The use of electromagnetic or eddy current sensors are considered prior art as these can be purchased on the open market today. The chaff retainer is also considered part of grinding methods as a necessary requirement to remove the undesirable components that result when grinding the feed material. These undesirables can be the chaff, metals, plastics, organics, or materials of different densities. The ventilation system described in this patent to cool the grinding chamber is typical of grinders since the force needed to grind the feed material is a direct force, thus correlating to heat generated by the grinding process.

The failure of prior art in producing low aspect ratio ground materials is a direct result of the voids, slip planes and slip dislocations associated with the material crystallinity and preferential cleavage plains of the feed material and the applied grinding forces. For example, when grinding bottle glass or plate glass (soda-lime glass), the traditional grinders produce aspect ratios ranging from 1-1 to 20-1. The inconsistency of the ground glass is related to inherent variety of shear planes and slip dislocations within the feed material with respect to the applied force.

Maitlen, et al. in U.S. Pat. No. 5,025,994 uses teeth on the rotors to cut or slice medical waste. Again, this method teaches that a force is needed and a hard surface, as described by the rotors with teeth, to grind the feed material. The rotor has teeth that can be angled for better cutting action depending on the feed material. This method requires a rotor with a plurality of teeth and it is these teeth that reduce the feed material. Similar methods are taught in the literature where paper products are shredded, wire is cut or plastic is ground using rotors with multiple cutting or slicing members to reduce the feed material in size.

There are numerous feed materials that are ground or pulverized such as the bottle glass, medical waste and ash from coal fired boilers. Skinner in U.S. Pat. No. 4,601,430 describes a method to grind ash particles using the same grinding chamber, rotor and fixed blades to physically hammer, cut or fracture the fly ash feed stock into smaller sizes. It utilizes a reversible rotation system with a controlled rotational speed at a relatively slow speed to accommodate the larger size fly ash feed material. Fly ash and grinding is very similar to other grinding systems that use blades on a rotating shaft opposed fixed blades on the chamber wall. They force the large feed fly ash material between the rotating blades and the fixed blades with a fixed clearance that is set for a pre-determined final grind particle size. This system also uses direct force input to reduce the feed material to smaller particles. This system relies on a dry, hot and friable feed material, otherwise this system would not be as effective if the feed material were cooled to ambient and contained water.

A more recent invention by Yanase in U.S. Pat. No. 6,070,817 uses a hollow rotor with feed media inside the rotor and uses a harder grinding media on the outside of the rotor to commutate to effect grinding. The rotor is rotated, and the pulverizing medium is moved in an up and down motion to provide the kinetics of grinding and the harder particles provide the force to reduce the feed material in size. Again, the grinding action is accomplished with physically moving the pulverizing material against the feed material in a rotating and translational movement with predetermined portals for sizing. This method of grinding is simply a modification of the old mortar and pestle. The grinding media is the pestle and the inside of the hollow rotor acts as the mortar. The feed material is introduced into the hollow rotor and the pulverizing material (pestle) grinds the feed material and allows it to communicate through the open, sized apertures. This method of grinding is being applied to aggregate (friable minerals and compounds), pigments, or for polishing stones or other decorative materials.

The prior art as a whole, thus, teaches various methods of grinding or pulverizing friable feed materials using various methods to fracture large particles to make smaller particles with hammers, chains or blades against hard surfaces, opposing larger and harder surfaces or by accelerating the feed material with centrifugal forces or by accelerating with a stream of gases and directed at a hard surface. The references also report the different feed materials but they are limited to a certain particle size reduction or particle size distribution. Flexibility of the prior art is limited by each method and is usually directed to individual applications or range of capabilities such as the coffee grinder or aggregate grinder. Energy requirements are also high when imparting direct or near direct kinetic energy into the feed material against the opposing hard surfaces. The references also do not report the efficiency or effectiveness of the grinding operation. A grinding method or pulverizing technique certainly can provide for a certain application; however, most prior art methods have been limited to a few areas of use.

The failure of the prior art is the inability or limited inability to reduce material particle size and distribution with minimal energy input, and be able to accommodate a mixed feed material for input, and be able to segregate out materials of different densities, morphologies or crystallinity. Although there are numerous grinding and pulverizing designs and techniques currently being used today, optimization and design flexibility is limited to only a few materials, size constraints, energy requirements and resulting shape and resulting sizes. Consequently, there is a need for a grinder or pulverizer and method of fracturing solid materials which can reduce the solid to very small particles, can be used for a variety of and combination of different solid materials and requires less energy input than currently available grinders to achieve a comparable reduction in particle size.

### SUMMARY OF THE INVENTION

We provide a pulverizer and method of pulverizing solid materials in which the feed material is accelerated down the grinding chamber toward the outlet of the grinding chamber where the feed material reaches the end of the grinding chamber and is redirected in reverse flow back toward the feed inlet of the grinding chamber. As the material is accelerated again, it encounters feed material coming from the feed inlet in the opposite direction, and collisions occur effecting particle size reduction. In the case of grinding bottles, the metal cap is removed and the paper or polymer labels are removed as the result of the particle on particle action.

We prefer to provide a grinding chamber that is designed to contain, and possibly further support, grinding by introducing a rough surface of small anvils. The feed material is directed down the predominately horizontal grinding chamber by a rotating center shaft affixed with tines, blades or hammers. The tines are spaced and articulated via predetermined timing that directs the feed material down the entire length of the grinding chamber. The tines are not designed to perform the primary grinding, rather they are available to perform some of the initial grinding if necessary.

The present grinding and pulverizing method lends itself well to grinding many different materials and options to reduce material in size while utilizing very little energy to accomplish this fundamental task.

The present invention uses particle-on-particle collisions as the predominate action to reduce the material in size. This action results in more cubic, rhombic, orthorhombic or poly-rhombic geometric shapes. This resulting shape more typifies the basic crystalline structure of the feed material being ground. The energy required to grind, as measured by the input energy to reduce feed material, is greatly reduced, while the resulting final grind material is more uniform in shape and size. The counter current flow developed by the tine, blades or paddles in the present invention provides the velocity necessary to produce the kinetic energy required to fracture and reduce particle size via material flow in the opposing direction.

Typical mortar and pestle grinding or hammer pulverizing is limited to how small the feed material can be reduced in size since there will always be increasing energy required to reduce the particle size as force is applied to reduce particle size. Whereas the present invention provides the potential to reduce the particle size to at least a single crystal size. Micron and sub-micron grinding has been demonstrated without high energy input because of the particle-on-particle impacts caused by the design of this technology.

Other objects and advantages of our pulverizer and method of fracturing solid materials will become apparent from a description of certain present preferred embodiments thereof which are shown in the drawings.

### BRIEF DESCRIPTION OF THE FIGURES

FIG. 1 is a side view, partially cut away, of a present preferred embodiment of our integrated in-line pulverizer.

FIG. 2 is a sectional view taken along the line II-II in FIG. 1.

FIG. 3 is a diagram showing the flow of particles according to the present invention.

### DESCRIPTION OF THE PREFERRED EMBODIMENTS

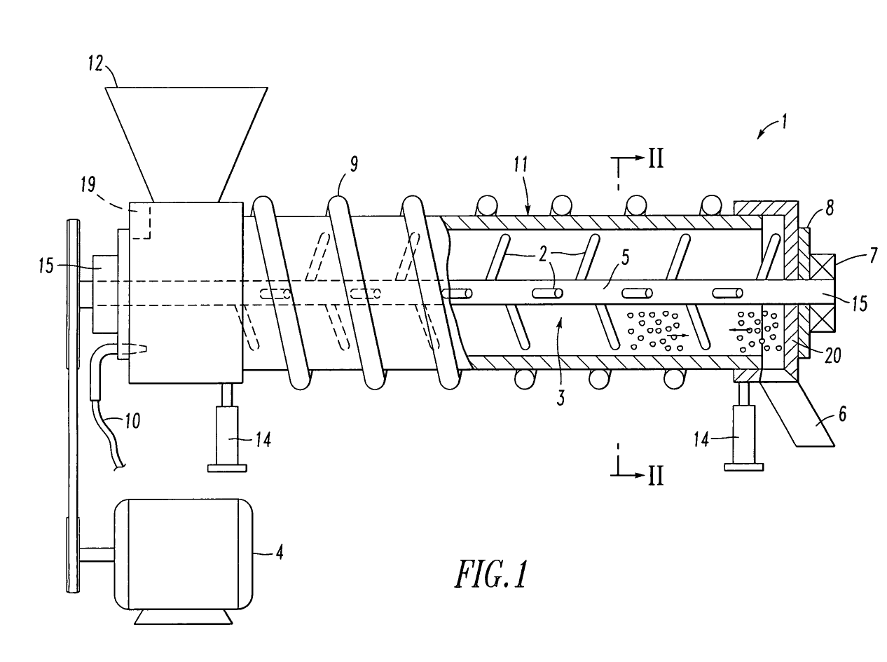

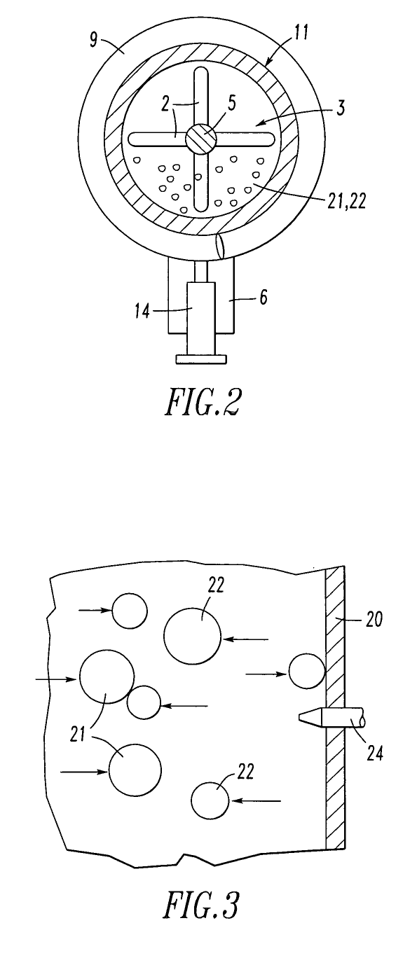

Referring to FIGS. 1 and 2 we provide a grinder 1 in which a housing 11 surrounds a grinding chamber 3. The grinding chamber 3 is fitted with a center rotating element 5 that has tines, paddles, anvils, blades, hammers or other projections 2 attached for the rotating action necessary for the translation of feed material through the grinding chamber. The chamber preferably has a smooth interior surface with the tines, paddles, blades or hammers traveling over and spaced away from that surface. If desired, baffles or bumps could be provided on this surface. The projections preferably are normal to the exterior surface of the center rotating member. The projections may be arranged in sets with each set in a single plane passing through the center rotating element or in a helix or double helix pattern. The projections may be attached in a manner that they can rotate around a longitudinal axis through the projection or pivot relative to the center rotating element. The center rotating element 5 is part of a rotor 15 that extends from the housing and is rotated by an external driver 4. This power device is preferably an electric motor connected to the rotor by a belt or gear train. Solid materials enter the chamber though an inlet 12 and are directed by the motion of the center rotating member toward a material outlet portal 6. The motor and the gears, or both, should be such that the speed of rotation of the rotor can be varied and that the rotor may be turned clockwise or counterclockwise. We further prefer to provide heating and cooling coils 9 around the chamber and the inlet so that the temperature of the solid materials being ground can be increased or decreased. We may also provide a microwave generator 19 which can direct microwave into the chamber. One can then vary the feed inlet material temperature and the temperature of the material within the chamber. One can optimize grinding by adjusting not only the temperature of the material but also by changing the center rotating element speed of rotation, tine/blade/paddle/ and/or hammer position, location or inclination, and the inclination or declination of the grinding chamber relative to the horizontal. Indeed, we prefer to provide a hydraulic cylinder 14 at each end of the chamber so that either end can be moved up or down. Changing the inclination of the chamber relative to horizontal can effect the dwell time of the feed material in the grinding chamber, particle size and particle size distribution as the material exits the grinding chamber. Movement of the feed material can be assisted with the addition of heated, cooled or high pressure gases. Consequently, we provide an injector 10 near the inlet for injecting heated, cooled or pressurized gas into the chamber. The material in the grinding process and the final ground material is contained inside the grinding chamber by external seals 8 to protect the bearings in collars 7 from the material being ground.

After solid materials enter the chamber they are directed along a linear path from the inlet 12 toward the outlet 6. The term linear path as used here means that the particles travel from one end to the other end of the pulverizer and does not mean that all or any particles must travel in a straight path. Indeed, there may be both laminar and turbulent flow of solid materials as they move along this liner path. Some particles can flow along a generally spiral or helical path. Different flows can be induced by adjusting the speed or reversing the direction of the center rotating element, repositioning the projections and injecting air or other gases into the chamber.

A wall 20 is provided adjacent the outlet at the end of the center rotating element. The wall is in the linear path along which the solid materials are directed. Consequently, they strike the wall and are reflected or deflected in a reverse direction along the linear path. At that time a portion of the solid materials within the chamber is moving in one direction along the linear path and a second portion of the solid material are moving in an opposite direction along the same path. Inevitably, the oppositely moving solid materials collide causing the colliding materials to fracture into smaller particles. The reverse flow of material creates a counter-directional flow of lower kinetic energy material. The flowing material within the chamber has a higher kinetic energy stored in each fragment than the counter flow material. When the oppositely moving particles collide they are thereby reduced in size. This action is shown in the diagram of FIG. 3. There solids 21 are moving towards the wall 20. Solids 22 have hit the wall and been reflected back along the linear path. One could reverse the rotation of the center rotating element to cause portions of the solid materials to change direction. Indeed, the pulverizer could be operated in cycles such that the direction of rotation of the center rotating element is changed periodically. One could also provide an air jet 24 or jets in wall 20 to inject air and thereby reverse the paths of a portion of the solid materials. Although the particles are illustrated as being spherical in the figures, it should be understood that in practice most particles will be multisided geometric shapes, not spheres.

The colliding action within the pulverizer produces ground and pulverized particles that are more rhombic, cubic, orthorhombic or rounded as the particle-on-particle collisions cause the particle size reduction. The resulting particles tend to have cleavage angles greater than 90° and elongated pieces, particularly slivers, are seldom produced. Aspect ratio of ground particles is typically less than 4 to 1. Particle size reduction is attributed primarily to particle-on-particle collisions and the resulting collisions provide the primary kinetic energy to reduce particle size. The particle on particle collisions will generate heat. This heat can drive off any water in the particles and can vaporize any water that otherwise enters the chamber.

The material being pulverized can be homogeneous or heterogeneous. The materials may have specific density less than 1, or may have a specific gravity greater than 1. The material may be particles of the same specific gravity or the same density or the same hardness or a mixture of particles having different densities, different specific gravities and/or different hardness. Materials of different densities or specific gravities tend to follow different paths. The denser materials tend to travel closer to the chamber wall while less dense materials tend to stay closer to the center rotating element. One may enhance grinding and pulverizing efficiencies by mixing materials of different densities. Providing countercurrent flow within the chamber will cause higher density materials to preferentially grind and pulverize lower density materials.

For some materials the particle on particle interaction will produce an electrical charge difference among particles. That charge difference can cause agglomeration of inorganic and organic contaminants which can then be segregated.

2. Our Performance Study

Performance studies have been carried out with plate glass, bottle glass, concrete, ceramics, pigments and amorphous materials. Validating the technology was initially accomplished using several sources of glass products with various amounts of organic and metallic contamination as well as moisture contents. It is most important to realize that the tines, blades or paddles, positioned in the standard helical pattern, have a primary function of moving material from one end of the grinder and back in contrast with other aforementioned technologies. The tines or other projections can function as a primary hammer when whole bottles of glass are introduced, however, the majority of grinding and pulverizing occurs during the translation of material along the grinding chamber via a radial component to each particle. The radial component of each particle displacement along the grinding chamber supports a pressure drop from the outer grinding chamber wall to the center-rotating member. This difference in pressure supports the segregation of smaller particles from larger particles as well as supporting the generation of a low level imposed electrical charge placed on organic and metallic contaminates. This is evidenced by the various performance tests that were run with mixed feeds.

Validating the technology in the test programs was accomplished with grinding normal glass bottles and pre-crushed glass with metal and plastic lids, corks, and labels intact. The whole bottles were introduced into the feed hopper of a pulverizer similar to that which was shown in FIGS. 1 and 2. The bottles were immediately broken into small pieces by the first tines. The smaller pieces of the bottle glass were then pushed down the pulverizer in a radial or general helical path with succeeding tines supporting a level of kinetic energy that facilitates translation along the grinding chamber, until they reached the end of the grinding chamber. The majority of the pieces were too large to exit the grinder during the first pass, therefore, they were redirected back in the direction of the feed inlet, or counter current to the initial feed material flow. This was accomplished by reversing the direction of rotation of the center rotating element to push the pieces back toward the feed inlet as promoted by the pressure differential within the grinding chamber. The acceleration and kinetic energy of the particles now traveling in opposite directions within the grinding chamber caused the feed material to collide with feed material traveling in the opposite direction. The collisions of the particles cause the friable material or other material with brittle characteristics to fracture into smaller particles, thus effecting the grinding process. The resulting particle size and distribution of sizes are determined by the size of the grinding chamber, speed of the center rotating member and the number and position of the tines, hammers and/or blades, and, the inclination or declination of the grinding chamber. The feed material can also contain up to 10 percent water because the particle on particle collisions can drive the moisture off as the result of exothermic heat liberated from particle on particle movement.

Reversing the rotation of the center rotating member can increase the particle dwell time within the grinding chamber and further decrease the particle size via extra fine grinding. Tests were conducted with the grinding chamber inclined from horizontal and the rotating speed of the center rotating member varied to develop multiple passes within the grinding chamber to facilitate extra fine grinding. It was found that micron size and sub-micron sized pulverizing and grinding are possible with adjustments of rotation, grinding chamber inclination, reversing rotation of the center rotating member and varying the rotating speed. Table 1 reports a sieve analysis of various feed materials and resulting particle sizes at three combinations of angle of the grinding chamber and rotation of the center rotating element.

TABLE 1

| | 4° Downhill | | 15° Downhill |
|---|---|---|---|
| | Tilt | 4° Downhill | Tilt |
| | Counter | Tilt | Counter |
| | Clockwise | Clockwise | Clockwise |
| | Rotation | Rotation | Rotation |
| | Weight in | Weight in | Weight in |
| Particle Size | Pounds | Pounds | Pounds |
| minus ¼, plus 10 mesh | 101.2 | 178.6 | 124 |
| minus 10, plus 20 mesh | 92 | 93 | 55 |
| minus 20, plus 30 mesh | 19.4 | 121 | 57.5 |
| minus 30, plus 50 mesh | 54.8 | | |
| minus 50, plus 80 mesh | 50.1 | | |
| minus 80 mesh | 20.1 | | |
| Total Weight | 337.6 | 392.6 | 236.5 |

While we have described and illustrated certain present preferred embodiments of our pulverizer and method for fracturing solid materials, it should be distinctly understood that our invention is not limited thereto, but may be variously embodied within the scope of the following claims.

We claim:

1. A pulverizer for fracturing solid materials comprising:
a housing forming a chamber and having an inlet for injecting material to be pulverized into the chamber and an outlet for discharging pulverized material from the chamber, the chamber having a smooth interior surface,
a rotor having a rotating center element mounted within the chamber, the rotating center element having a plurality of projections connected to the rotating center element and extending outwardly, the rotor being positioned so that there is clearance between the rotating center element and the housing such that the rotating center element can rotate within the chamber,
a power device connected to the rotor for rotating the rotating center element such that when the rotating center element is rotated in a selected direction material to be pulverized is directed from the inlet toward the outlet, and
a wall positioned near the outlet so that at least a portion of the material to be pulverized strikes the wall and reverses flow direction to strike and fracture a second portion of material to be pulverized.

2. The pulverizer of claim 1 wherein the projections are tines, blades, anvils or hammers.

3. The pulverizer of claim 1 wherein the center rotating element is comprised of a shaft having an exterior surface and the projections are normal to the exterior surface.

4. The pulverizer of claim 1 wherein the center rotating element is comprised of a shaft having an exterior surface and the projections are attached to the exterior surface in a helix pattern.

5. The pulverizer of claim 1 wherein the center rotating element is comprised of a hollow, solid or splined shaft and the projections are selected from the group consisting of tines, paddles and blades.

6. The pulverizer of claim 1 where in the power device causes the rotating center element to alternately rotate in a clockwise direction and in a counterclockwise direction.

7. The pulverizer of claim 1 wherein the center rotating element is comprised of a shaft having an exterior surface and the projections are comprised of a plurality of sets of projections each set of projections in a common plane and attached along one of several spaced apart circumferential rings on the exterior surface.

8. The pulverizer of claim 1 also comprising a heating device attached to the housing.

9. The pulverizer of claim 1 also comprising at least one air jet attached to the housing and positioned to direct air into the material to be pulverized.

10. The pulverizer of claim 1 also comprising a cooling device attached to the housing.

11. The pulverizer of claim 1 also comprising a microwave signal generator attached to the housing for directing microwave signals into the chamber.

12. The pulverizer of claim 1 wherein at least some of the projections are attached to the rotating center element so that the projection may rotate about an axis through the projection.

13. The pulverizer of claim 1 wherein at least some of the projections are attached to the rotating center element so that the projection may pivot relative to the rotating center element.

14. The pulverizer of claim 1 also comprising at least one baffle attached to the smooth interior surface of the housing.

15. A method for fracturing solid materials comprising
directing solid materials along a linear path within a chamber in a first direction, and
redirecting a portion of the solid materials in an opposite direction along the linear path to cause the portion of solid materials which has been redirected to strike a second portion of the solid materials traveling along the linear path in the first direction causing at least some of the solid materials to fracture.

16. The method of claim 15 wherein all of the solid materials are of like density.

17. The method of claim 15 wherein the material of like density is mixed with material of different density to enhance grinding and pulverizing efficiencies.

18. The method of claim 15 wherein the solid materials have multiple densities, and hardness.

19. The method of claim 15 also comprising separating the solid materials according to material density.

20. The method of claim 15 wherein the solid materials have multiple densities and further comprising providing a counter current material flow within the chamber to cause higher density materials to preferentially grind and pulverize lower density materials.

21. The method of claim 15 wherein the solid materials have a specific gravity less than one.

22. The method of claim 15 wherein the solid materials have a specific gravity greater than one.

23. The method of claim 15 also comprising heating the solid materials.

24. The method of claim 15 also comprising cooling the solid materials.

25. The method of claim 15 also comprising directing a microwave signal through the solid materials.

26. The method of claim 15 wherein a majority of cleavage angles in the fractured solid materials-are greater than 90° and have a cubic, rhombic, orthorhombic, poly-rhombic or normal crystalline morphology with typical aspect ratio of less than four to one.

27. The method of claim 15 also comprising pre-heating the solid materials above ambient temperatures prior to directing the solid materials along the linear path.

28. The method of claim 15 also comprising cooling the solid materials prior to directing the solid materials along the linear path to temperatures below ductile to brittle transition temperature for the solid materials.

29. The method of claim 15 also comprising injecting at least one of hot, cold and dry gases into the solid materials.

30. The method of claim 15 also comprising producing an electrical charge difference within the solid materials as the result of particle on particle interaction that charges and causes agglomeration of inorganic and organic contamination and segregates the contamination.

31. The method of claim 15 also comprising creating both laminar and turbulent flow of the solid materials as they move along the linear path.

32. The method of claim 15 wherein the solid materials contain water and also comprising driving off the water by generating heat as part of particle on particle collisions.
